(19) United States
(12) Patent Application Publication
(10) Pub. No.: US 2026/0194373 A1
(43) Pub. Date: Jul. 9, 2026

(54) ELECTRICAL SENSOR ASSEMBLY, SENSOR ARRANGEMENT INCLUDING MATING CONNECTOR, AND KIT

(71) Applicants: TE Connectivity Solutions GmbH, Schaffhausen (CH); Tyco Electronics (Shanghai) Co., Ltd., Shanghai (CN)

(72) Inventors: Deepan Ponraj MUTHUPANDI, Bangalore (IN); Tian XIA, Shanghai (CN); Santosh KAMBALI, Bangalore (IN); Minghui SHAO, Shanghai (CN)

(21) Appl. No.: 19/443,949

(22) Filed: Jan. 8, 2026

(30) Foreign Application Priority Data
Jan. 9, 2025 (IN) 202541001963

(51) Int. Cl. G01D 11/24

(52) U.S. Cl. CPC G01D 11/245

(57) ABSTRACT

An electrical sensor assembly includes an electrical plug housing for mating a mating connector, a circuit board in the plug housing, a plurality of terminals which make electrical contact to a surface of the circuit board, and a sensor on the circuit board in electrical contact with a plurality of electrical connectors on the surface of the circuit board. The electrical connectors press against the respective terminals for making the electrical contact. A sensor arrangement can include the electrical sensor assembly and a mating connector that connects to the electrical plug housing. The mating connector includes a plurality of complementary terminals that electrically connect to the terminals.

### CROSS REFERENCE TO RELATED APPLICATIONS

This application claims the benefit of IN Application No. 202541001963, filed 9 Jan. 2025, the subject matter of which is herein incorporated by reference in its entirety.

### BACKGROUND OF THE INVENTION

Electrical sensors can be used for taking physical measurements. Electrical connectors are used for connecting sensors to other devices such as electrical appliances. Sensors can include proximity sensors, which can be used to ensure that connections are made and/or aid in identifying the connection of devices. Sensors can provide data, e.g. for confirming an operational state and/or troubleshooting equipment.

Some connectors can be used repeatedly, e.g. can be disconnected and reconnected, or can be used flexibly with many other different types of electrical components.

It can be desirable that a variety of different sensors can be connected to the same component and/or through the same mating connection. It is also desirable to keep manufacturing costs low; simplify assembly and/or disassembly procedures; and ensure robust electrical contact between contacting elements. The ability to use the same electrical sensor assembly and/or same plug with various kinds of sensors and/or mating connectors can reduce manufacturing costs, due to the economy of scale.

### BRIEF DESCRIPTION OF THE INVENTION

In one embodiment, an electrical sensor assembly is provided including an electrical plug housing for mating a mating connector, a circuit board in the plug housing, and a plurality of terminals which can be inserted into the plug housing. The terminals can make electrical contact to a surface of the circuit board. The assembly includes a sensor on the circuit board in electrical contact with a plurality of electrical connectors on the surface of the circuit board. The electrical connectors press against the respective terminals for making the electrical contact. The electrical contact can be reversible. For example, the terminals make reversible electrical contact to a surface of the circuit board. The sensor can be, for example, a hall sensor or reed sensor.

Electrical sensor assemblies, sensor arrangements, and kits can include the following further developments and/or embodiments, which can be combined singly or multiply, independently of each other unless indicated otherwise, for further embodiments.

The electrical connectors of the circuit board can be on a top surface of the circuit board. The electrical connectors of the circuit board can be elastically pressed against the respective terminals, particularly the bottom surfaces thereof. The elastic connection can simplify assembly, disassembly, and/or change of components, such as the circuit board. Alternatively/additionally, the elastic connection can provide a robust elastic connection resistant to vibration.

The electrical plug housing can include a mating face for mating the mating connector, particularly exactly one connector face. A cross section of the electrical plug housing at the mating face, and parallel thereto, is such that at least 60%, 70%, 80%, or 90% of the cross-sectional area of the electrical plug housing is for mating to the mating connector. The 60%, 70%, 80%, or 90% of the can include complementary structures for making the connection A relatively large fractional area used for mating can provide an efficient use of space, e.g. to make a small connector. The electrical plug housing can be an end-unit. The assembly can be configured to be an end-of-line connection, e.g. having exactly one mating face.

The electrical plug housing can be an end of line unit, e.g. for connecting at the end of an electrical circuit. An end of line unit can be easily be exchanged.

The terminal(s) of the assembly can include at least one sensor terminal configured to transmit sensor data from the sensor; optionally at least two sensor terminals. Two terminals can allow differential sensing for enhanced accuracy.

The terminal(s) of the electrical sensor assembly can include crimps, particularly crimps within the electrical plug housing, such as crimps opposite to mating ends, e.g. male or female ends of the terminal(s). The mating ends can be configured to mate complementary terminals at the connector face. Terminals with crimps can be inexpensive and widely available.

The electrical sensor assembly can include a rear cover, such as a terminal position assurance member (TPA), which can cover an opening of the electrical plug housing. The opening can be for insertion of the circuit board and terminals, e.g. during assembly. The opening and rear cover can be on an opposite side of the electrical plug housing as the mating face. This geometry provides easy assembly and/or disassembly.

The rear cover can be reversibly attachable at the rear of the electrical plug housing. The rear cover can include pillars on an inside face which may form a wall of an internal cavity of the electrical plug housing for holding the circuit board and/or terminal(s). The pillars can possibly push against a rear edge of the circuit board during insertion of the circuit board into the electrical plug housing. This can aid in assembly and/or disassembly.

The electrical plug housing can provide a cavity for insertion of a securing element for locking the electrical sensor assembly to the mating connector. The securing element can be a contact position assurance member, CPA. This can ensure robust electrical connections, resistant to vibrations.

The electrical sensor assembly can include at least one latching member for engaging the mating connector; and/or a moveable member configured to release the at least one latching member from engagement with the mating connector. The securing element can be reversibly insertable in the cavity. When the securing element is inserted in the cavity, the securing element can prevent movement of the moveable member for releasing the electrical sensor assembly from the mating connector. The securing element, when present in the cavity, can prevent release of the electrical sensor assembly from the mating connector. This can ensure robust electrical connections, resistant to vibrations.

The electrical sensor assembly can be plug-like. Such an assembly can be easily exchanged.

A sensor arrangement is disclosed herein, which includes the electrical sensor assembly as described according to any embodiment herein, and a mating connector that connects to the electrical plug housing. The mating connector can include a plurality of complementary terminals that electrically connect, possibly directly, to the terminals.

The mating connector can include at least one attachment structure for attaching to an appliance. The attachments structures of the mating connector can be the sole mechanical/physical attachment structures for mechanically/physically attaching the sensor arrangement to an appliance. The attachment structures can be on an outside surface of the mating connector. Such an assembly can be easily exchanged.

In a fully mated configuration of the sensor arrangement, the electrical sensor assembly and the mating connector are fully mated, and the securing element can be in a locking position in the cavity. The securing element, in the locking position, can prevent movement of the moveable member for releasing the electrical sensor assembly from the mating connector. The moveable member may release the connection between the electrical sensor assembly and the mating connector when it moves, e.g. only after the securing element has been removed, and the moveable member is depressed to disengage a latching mechanism between the sensor assembly and the mating connector. This can ensure robust electrical connections, resistant to vibrations.

Herein is disclosed a kit, including: at least one circuit board; a plurality of terminals; a sensor on the at least one circuit board making electrical contact with a plurality of electrical connectors on the surface of the circuit board; and an electrical plug housing configured for mating a mating connector. The electrical plug housing can be configured for insertion of the plurality of terminals and one of the at least one circuit board. The electrical connectors on the surface of the circuit board can be configured to make electrical contact to the terminals, e.g. reversibly, when the circuit board and the terminals are in the electrical plug housing. A rear face of the housing can accept the circuit board and terminals for insertion into the housing. Such a kit can allow a user to determine the configuration of the assembled device.

Herein “and/or” can mean at least one of the listed elements. For example, “A and/or B” means: only A; only B, at least A; at least B; or at least A and B. For example, “X, Y, and/or Z” means: only X; only Y; only Z; at least X; at least Y; at least Z; only X and Y; only X and Z; only Y and Z; only X, Y, and Z; at least X and Y; at least X and Z; at least Y and Z; or at least X, Y, and Z. In another illustrative example, “mechanical/physical” means “mechanical and/or physical,” e.g. a “/” can mean “and/or.”

Herein an “(s)” at the end of a word means one or more; for example a hole(s) is one or more holes. In the following, embodiments are described with the aid of figures to aid in understanding. In the figures, elements which correspond to one another in terms of structure and/or function are provided with the same reference signs. The combinations of features shown and/or described in the individual embodiments are for explanatory purposes only. According to the above explanations, a feature of an embodiment can be omitted if its technical effect is not important for a particular application. Conversely, according to the above explanations, a further feature can be added to an embodiment if its technical effect should be advantageous or necessary for a particular application.

### BRIEF DESCRIPTION OF THE DRAWINGS

In the following, several examples are described. In the figures:

FIG. 1 shows a kit and/or a sensor assembly, according to embodiments described herein;

FIG. 2 shows a sensor arrangement, according to embodiments;

FIG. 3 shows, according to embodiments, a sensor arrangement;

FIG. 4 shows, according to embodiments, an electrical plug housing and mating housing; an engaged connector assembly;

FIG. 5 shows, according to embodiments, a circuit board and terminal(s); and

FIG. 6 shows, according to embodiments, an electrical plug housing.

### DETAILED DESCRIPTION OF THE INVENTION

The examples described herein are for illustrative purposes.

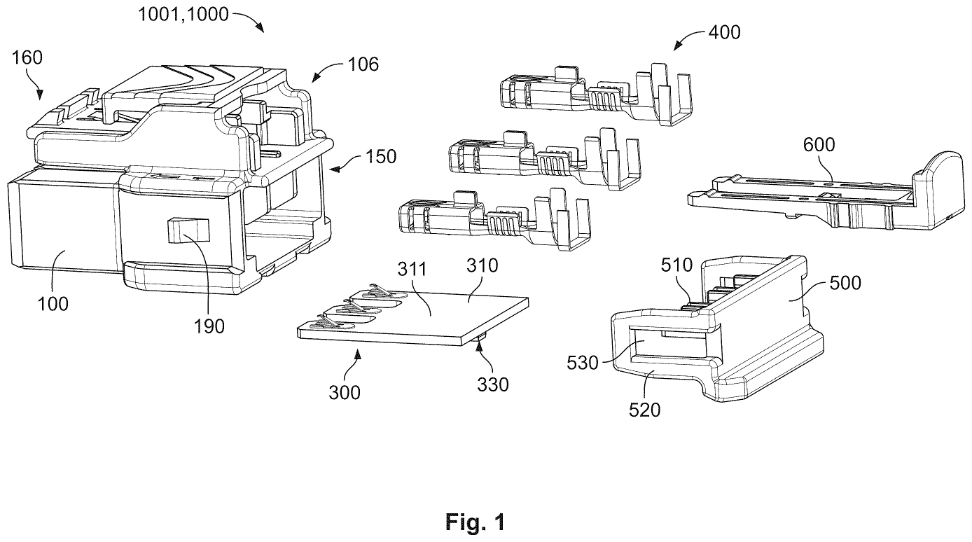

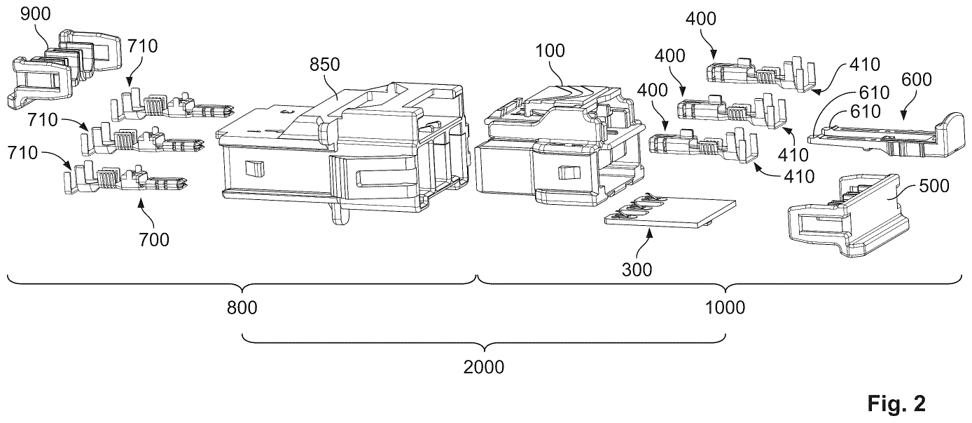

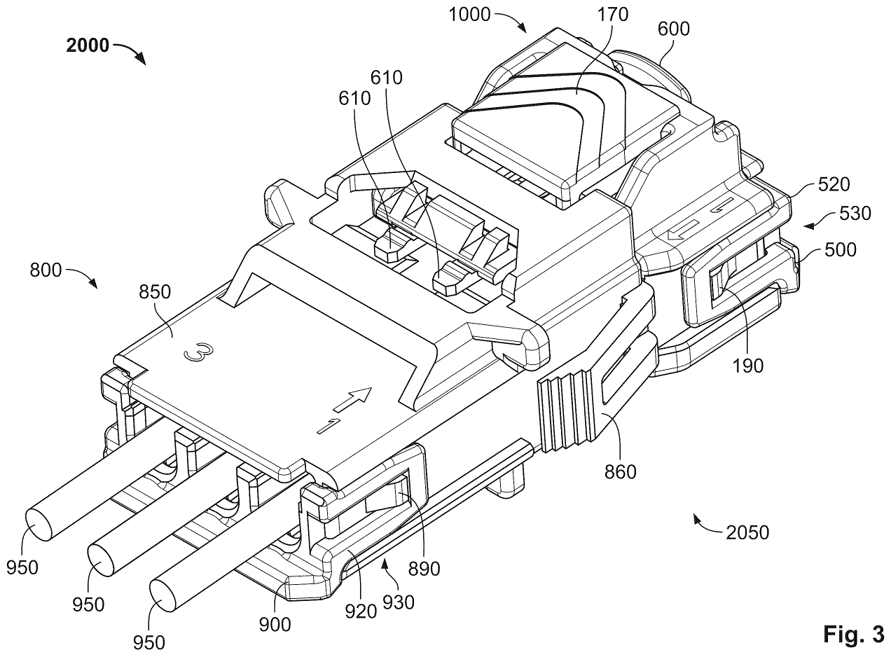

FIG. 1 illustrates a kit 1001, according to an embodiment, which can be used to make an electrical sensor assembly 1000, e.g. an electrical sensor assembly 1000 according to any embodiment described herein. Alternatively or additionally, the kit 1001 can make a sensor arrangement 2000, such as that of FIG. 2 or FIG. 3 in a connected configuration.

The kit 1001 can include a circuit board(s) 300; a plurality of terminals 400; and a sensor 330 on the circuit board(s) 300. The sensor 330 can make electrical contact with a plurality of electrical connectors 320 on the surface 310 of the circuit board 300. The kit 1001 includes an electrical plug housing 100 that mates with a mating connector 800 (see FIG. 2 or 3, for example). The electrical plug housing 100 can accept the insertion of terminals 400 and a circuit board(s) 300. The electrical connectors 320 on the surface 310 of the circuit board 300 can make electrical contact to the terminals 400, e.g. when the circuit board 300 and the terminals 400 are in the electrical plug housing 100.

The kit 1001 can allow different kinds of sensors, aiding in providing a flexibly configurable sensor assembly 1000.

The kit 1001 can be provided with different sensors in addition to a single sensor 330 on the circuit board 300. Alternatively/additionally, a kit may include a plurality of circuit boards which each has a different kind of sensor and/or different arrangement of sensors. For example, the kit 1001 can include a circuit board 300 with a reed sensor and a circuit board 300 with a hall sensor.

The kit 1001 can include multiple circuit boards 300 while allowing the assembled sensor assembly 1000 to house exactly one circuit board 300. The kit 1001 can allow the user to select which type of circuit board 300 and/or sensor(s) 330 to use in the sensor assembly 1000.

FIG. 1 also illustrates an exploded view of a sensor assembly 1000, according to an embodiment. The sensor assemblies described herein, such as that explained with referenced to FIG. 1, can be made by a kit, e.g. a kit as described herein. A sensor assembly 1000 can include an electrical plug housing 100 for mating a mating connector 800, a circuit board 300 in the plug housing 100, and terminal(s) 400 which can be inserted into the plug housing 100. The terminal(s) 400 can make electrical contact to a surface 310 of the circuit board 300, e.g. reversible contact. Reversible contact can allow users to replace the circuit board 300, for example, to utilize a differently configured circuit board 300, e.g. one with a different type of sensor 330. The sensor 330 on the circuit board 300 can be in electrical contact with electrical connector(s) 320 on the surface 310 of the circuit board 300. When the sensor assembly 1000 is assembled, the electrical connector(s) 320 can press against respective terminal(s) 400 for making electrical contact.

A plug-like electrical sensor assembly 1000, e.g. one including an electrical plug housing 100 can be easily mated to a complementary connector, e.g. a mating connector 800. It is possible to have different sensors 300 housed within different respective electrical sensor assemblies 1000, each of which can be plugged into the same complementary connector and/or mating connector 800. The housing 100 can include an opening 150, e.g. at the back. The circuit board 300 and/or terminals 400 can be inserted through the opening 150 into the housing 100. The opening 150 can be on the opposite side of the housing 100 as a mating face 160, the mating face 160 being shaped for connecting the electrical sensor assembly 1000 to a mating connector 800.

The electrical sensor assembly 1000 can include a rear cover 500, which can be a terminal position assurance (TPA) member. The rear cover 500 can cover the opening 150 of the housing 100 into which the terminal(s) 400 and circuit board 300 are inserted. On the opposite side of the housing 100 of the rear cover 500 can be the mating face 160.

The rear cover 500 can include pillars 510 which can aid in insertion, placement, and/or holding of the terminals 400 and/or circuit board 300. The pillars 510 can aid in pushing the circuit board 300 and/or terminal(s) 400 forward during installation of the circuit board 300 into the housing 100 through the opening 150.

The rear cover 500 can be reversibly attached at the rear of the housing 100. The rear cover 500 can attach to the housing 100, e.g. with a latching mechanism. The rear cover 500 can include an elastic arm 520 that slides over the outside of the housing 100, for latching the rear cover 500 to the housing 100. The elastic arm 520 can include a slot 530 that engages a protrusion 190 on the outside of the housing 100, for latching.

The mating face 160 of the housing 100 can be configured to mate the mating connector 800, e.g. by having a complementary shape and/or providing access to the mating ends of terminals 400. There can be exactly one mating face 160 of the electrical sensor assembly 1000.

A cross section of the electrical plug housing 100 at the mating face 160, and parallel thereto, can be such that at least 60%, 70%, 80%, or 90% of the cross-sectional area of the electrical plug housing 100 is for mating to the mating connector 800. The mating face 160 can include complementary structures for making the connection, e.g. to form press fit and/or latching connections. Having a large fractional area for making connections can be an efficient use of space and/or keep the size small.

The housing 100 can provide a cavity 106 for insertion of a securing element 600 for locking the electrical sensor assembly 1000 to a mating connector 800.

FIG. 2 illustrates a sensor arrangement, according to an embodiment, in an exploded view. A sensor arrangement 2000 includes an electrical sensor assembly 1000 as described herein, and a mating connector 800 that is complementary to the electrical sensor assembly 1000. A mating connector 800 can include mating terminals 700 that connect to the terminals 400 of the sensor assembly 1000, e.g. when the sensor assembly 1000 is plugged into the mating connector 800, to electrically connect the sensor assembly 1000 and mating connector 800.

As shown in FIG. 2, the mating connector 800 can include a mating housing 850, terminal(s) 700, and front cover 900. The front cover 900 can be a terminal position assurance element (TPA). The front cover 900 can ensure that the terminals 700 are correctly positioned within the mating housing 850, when the mating connector 800 is assembled. The mating connector 800 can connect to the electrical plug housing 1000. The terminal(s) 700 of the mating connector 800 can be complementary terminals, that electrically connect to the terminal(s) 400 of the sensor assembly 1000.

The terminals 400 of the sensor assembly 1000 and terminals 700 of the mating connector 850 can be configured to electrically connect to each other, e.g. reversibly. A reversible connection can allow the sensor assembly 1000 to be easily replaced, e.g. to change the sensing mechanism to that of another sensor assembly 1000, or to replace a faulty sensor 330. The terminals 400 of the sensor assembly 1000 and terminals 700 of the mating connector 800 can directly connect to each other.

The terminal(s) 700 of the mating connector 800 can include crimps 710 which can be used to attach wires 950, e.g. wires (see FIG. 3) that lead to an electrical appliance.

FIG. 3 illustrates a sensor arrangement, according to an embodiment. A sensor arrangement 2000 can include a sensor assembly 1000 as described herein and a mating connector 800.

The mating connector 800 can include attachment structure(s) 860 for mechanically/physically attaching the mating connector 800 to an appliance. The attachment structure(s) 860 for mechanical/physical attachment can be the sole attachment structures for mechanical/physical attachment of the sensor arrangement 2000 to an electrical appliance. The attachment structure(s) 860 can be on an outside surface of the mating connector.

For example, the attachment structure(s) 860 includes a clip, harness, latch, or elastic arm with groove. The sensor assembly 1000 can plug into the mating connector 800 such that the sensor assembly 1000 does not attach directly to the appliance. The sensor assembly 1000 can be easily removed from the sensor arrangement 2000, e.g. for replacement. The mating connector 800 can have the sole attachment structure(s) 860 for mechanical attachment of the sensor arrangement 2000 to the appliance, e.g. for physical attachment. Electrical wire(s) 950 can be coupleable to the mating connector 800.

The front cover 900 can fit over the front face of the mating connector 800 which can be opposite to the rear cover 500. The front cover 500 can fit to the mating connector 800 and the rear cover 500 to the sensor assembly 1000. The rear cover may be a panel or the like, such that the rear face of the sensor arrangement 2000 is closed. The front cover 500 can include hole(s) for the passage of wire(s) 900 into the mating connector 800. The mating housing 850 can have a protrusion 890, e.g. on the outside, for latching the front cover 500. The front cover 900 can have an elastic arm 920 with a slot 930 which can accept the protrusion 890 to form a latching connection, similar to the arm 520 of the rear cover 500 that forms a latching connection with a protrusion 190 of the plug housing 100. The sensor arrangement 2000 can have a fully mated configuration 2050, such as is shown in FIG. 3.

The sensor arrangement 2000 can include a securing element 600 (see FIG. 1). The securing element 600 can be inserted into a cavity 106 of the housing 100 (see FIG. 1). When inserted, the securing element 600 can prevent movement of a moveable member 170, e.g. a pressable 20 member, of the housing 100. When the securing element 600 is absent or removed from the cavity 106, the moveable member 170 can be operable to disengage a latching connection between the sensor assembly 1000 and the mating connector 800, e.g. between the electrical plug housing 100 and the mating housing 850.

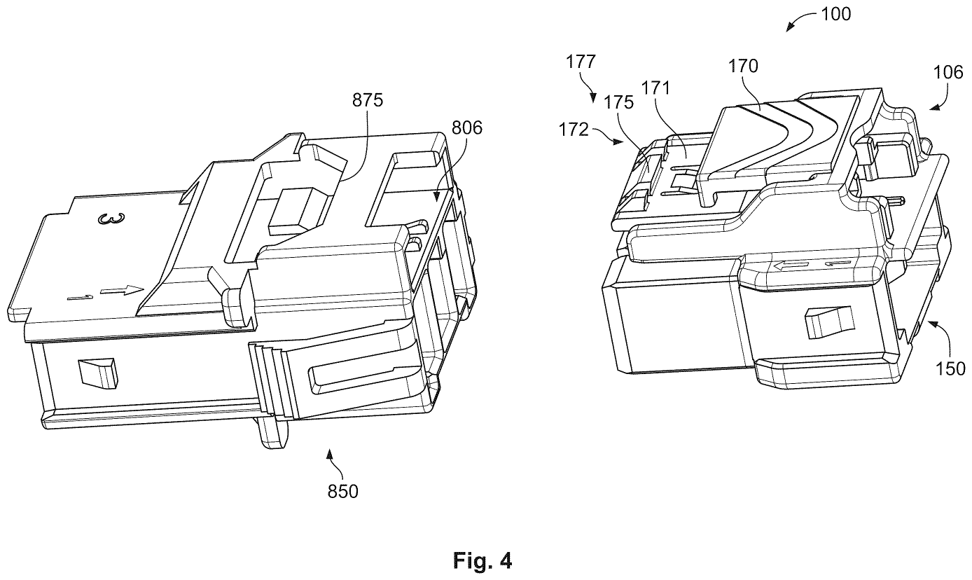

FIG. 4 shows an electrical plug housing and mating housing, according to embodiments. The electrical plug housing 100 and the mating housing 850 can fit together, e.g. reversibly, to make an electrical connection.

The electrical sensor assembly 1000 can include at least one latching member 172 for engaging the mating connector 800; alternatively/additionally the moveable member 170 can be operable to release the at least one latching member 172 from engagement with the mating connector 800. The latching member(s) 172 can include an elastic member 171, front edge thereof 177, and/or protrusion(s) 175 for engaging with a ledge 875 of the mating connector 800.

For example, a latching connection can be made between the front edge 177 of an elastic member 171 of the electrical plug housing 100 and a cavity 806, e.g. slot-like cavity, of the mating housing 850. Protrusion(s) 175 on the elastic member 171 can be caught by a ledge 875 of the cavity 806 to prevent disassembly of the sensor arrangement 2000 when the sensor arrangement 2000 is in the assembled state. Movement, e, g. pressing, of the moveable member 170 can push the protrusions 175 below the ledge 875, allowing the mating housing 850 and plug housing 100 to be separated, e.g. allowing the arrangement 2000 to transition to an unassembled state.

The securing element 600 can be reversibly insertable in the cavity 106 of the housing 100. Alternatively/additionally, when the securing element 600 is inserted in the cavity 106, the securing element 600 prevents movement of the moveable member 170 for releasing the electrical sensor assembly 1000 from the mating connector 800.

The securing element 600, when inserted into the cavity 106 after the mating connector 800 and sensor assembly 1000 are mated, can prevent the moveable member 170 from moving. Alternatively/additionally, the sensor arrangement 2000 is prevented from being disassembled, e.g. unless the securing element 600 is removed from the cavity 106 of the plug housing 106.

For example, the moveable member 170, when the securing element 600 is absent, is sufficiently moveable to make contact with the elastic member 171 and move the elastic member 171 to disengage the protrusions(s) 175 (which can be at the end of the elastic member 171) from the latching connection made between the protrusion(s) 175 and the ledge 875.

During assembly, the elastic member 171 can be inserted into the cavity 806 of the mating housing 850. The assembled state can be such that the protrusion(s) 175 on the elastic member 171 are forward of the ledge 875 and extend upward above the ledge 875. The protrusion(s) 175, in the assemble state, can prevent the housing 100 and mating connector housing 850 from being pulled apart.

The securing element 600 can further aid in ensuring that the connection stays intact during harsh conditions (e.g. vibrating). The securing element 600 can have at least one protrusion 610 that at least partially hinders removal of the securing element 600, e.g. at least partially hinders removal of the securing element 600 when the securing element 600 is fully inserted in the cavity 106 of the housing 100. The protrusion 610 of the securing element 600 can engage the elastic member 171, e.g. from the opposite side as the moveable member 170, to function to hinder removal of the securing element 600. The protrusion(s) 610 can engage the front edge 177 of the elastic member 175, for example, when the securing element 600 is fully inserted in the cavity 106, e.g. to hinder withdrawal of the securing element 600 from the cavity 106. In a fully mated configuration, the electrical sensor assembly 1000 and the mating connector 800 are fully mated. In the fully mated configuration: the securing element 600 can be in a locking position in the cavity 106 of the plug housing 100; alternatively/additionally, the securing element prevents movement of the moveable member 170 for releasing the electrical sensor assembly 1000 from the mating connector 800.

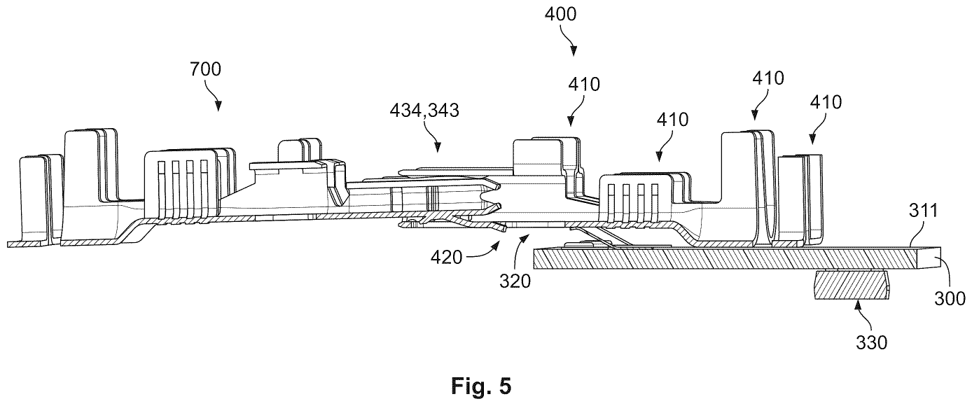

FIG. 5 illustrates electrical connections between a circuit board and terminal(s), according to embodiments described herein.

The electrical connectors 320 of the circuit board 300 can be on the opposite surface to the sensor(s) 300. The electrical connectors 320 of the circuit board 300 can be on a top surface 311 of the circuit board 300. The electrical connectors 320 can elastically press against the respective terminals 400, particularly the bottom surfaces 420 thereof. The elasticity can allow for the circuit board 300 to be replaced and/or for assembly of different configurations of the sensor assembly 1000, e.g. sensor assemblies 1000 having different sensor(s) 300. The circuit board 300 can have one or more sensors. Multiple sensors of the same type can provide redundancy and therefore extend the life of the sensor assembly 1000 in case one sensor malfunctions. Multiple sensors of different types can allow the sensor assembly 1000 to perform multiple kinds of sensing, e.g. proximity sensing and temperature sensing.

Data from the sensors 300 can be transmitted through at least one of the terminal(s) 400. One or more of the terminal(s) 400 can be a sensor terminal that transmits the sensor data from the sensor(s) 330. Two sensor terminals, or more, can provide differential output, redundant output, and/or output from multiple sensors 300.

The terminals 400 can include crimps 410. Male or female terminals configured to crimp to wires are inexpensive and widely available. The male or female end of the terminal 400 are configured to mate with terminal(s) 700 of a mating connector. The crimps can be on the opposite side of the mating end, e.g. male or female end, of the terminal 400. The crimping ends of the terminals 400 can be used to reversibly make electrical contact with the sensor(s) 330 of the circuit board 300, e.g. via the electrical connectors 320 on the circuit board 300.

The crimps 410 can be within the housing 100 of the sensor assembly 1000, when assembled. The electrical connectors 320 of the circuit board 300 can press against the bottom 420 of the terminal 400, e.g. beneath the crimps 410, which may be left open, e.g. uncrimped. The terminals 400 in the housing 100 do not have to be crimped to wires. By making electrical contact between the bottoms of the terminal(s) 400 and the electrical connectors 320 on the top surface 311 of the circuit board 300, using elastically deflectable electrical connectors 320, it can be possible to more easily replace the circuit board 300 of the sensor assembly 1000. Using terminals 400 with crimps 410 can reduce costs, e.g. because such terminals may be widely commercially available and inexpensive, e.g. even if the crimps are not used.

Mating ends 343, 434 of the terminals 400, 700 of the electrical sensor assembly 1000 and mating connector 800 can make electrical contact when the sensor arrangement 2000 is assembled. For example, the terminals 400 have female mating ends 434 and the mating connector 800 and/or terminal(s) 700 has male ends 343. The reverse is contemplated. Other mating features of the mating ends 343, 434 are also possible. A reversibly connectable mating end 343, 434 is desirable, to allow the sensor arrangement 2000 to be disconnected easily.

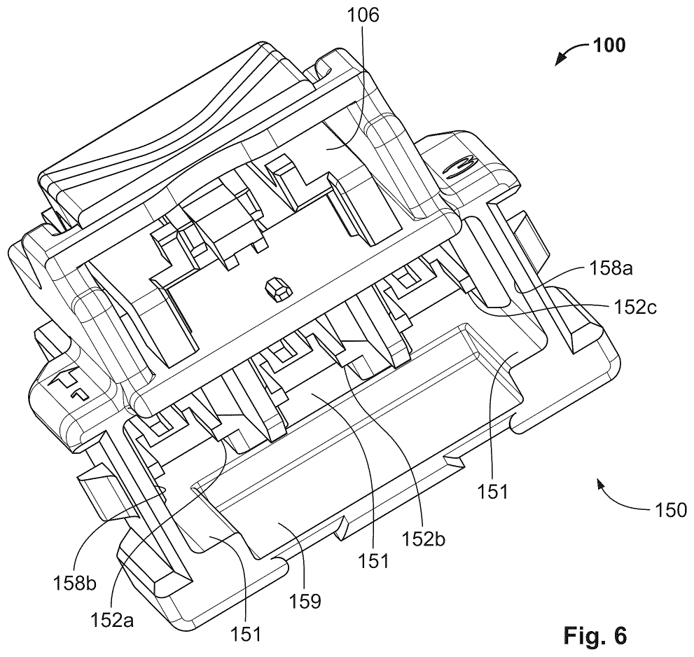

FIG. 6 illustrates, according to an embodiment, a view of the housing 100. The opening 150 of the housing 100, e.g. at the rear, can be for insertion of the board 300 and/or terminal(s) 400. The opening 150 can be large enough to accommodate one or more sensors 330 attached to the circuit board 300, such as a Hall sensor and/or reed sensor. The interior of the housing 100 can include a space 159 configured to be beneath the circuit board 300 which can accommodate one or more sensors 300 at the bottom surface of the circuit board 300. The interior of the housing 100 can include one or more supporting surfaces 151 which are configured to make contact with the circuit board 300, such as the bottom surface thereof. The supporting surface(s) 151 can include a surface configured to be directly beneath the electrical connectors 320 which may be on the top surface 311 of the circuit board 300. The supporting surface(s) 151 can aid in ensuring robust electrical contact between the terminal(s) 400 and the circuit board 300. The supporting surface(s) 151 can be at the front edge and side edges of the bottom of the circuit board 300, when the assembly 1000 is assembled. The supporting surface(s) 151 can leave space open at the rear surface (e.g. directly in front of the rear cover 500) and in the middle of the circuit board 300, e.g. to leave adequate space for sensor(s) 300 and/or other electrical components at the surface of the circuit board 300. The space for sensor(s) can be at the top and/or bottom surface of the circuit board 300.

The interior of the housing 100 can include at least one second supporting surface 152a, 152b, 152c above at least one first supporting surface 151, e.g. directly above a forward portion of the first supporting surface(s) 151. A gap between the first and second supporting surfaces 151, 152a, 152b, 152c can be approximately the width of a printed circuit board, e.g. adequate for the supporting surfaces 151, 152a, 152b, 152c of the inside of the housing 100 to make contact with both the top and bottom surfaces of the circuit board 300. This can aid in stabilizing the electrical connections, e.g. by restricting vertical motion of the circuit board 300. The supporting surfaces 151, 152a, 152b, 152c, can aid in vertically stabilizing the circuit board 300 and/or stabilizing the electrical connection between the board 300 and the terminal(s) 400.

The interior of the housing 100 can include lateral walls 158a, 158b. For example, opposite lateral walls 158a, 158b can prevent lateral motion of the circuit board 300.

The sensor assembly 1000 and sensor arrangement 2000 described herein can be provided as a kit 1001, e.g. a disassembled kit. A kit may include more than one circuit board that are configured differently from each other, e.g. by including different sensors and/or sensor(s), e.g. to perform variable sensing functions. particularly contemplated. Circuit boards that include hall and/or reed sensors are particularly contemplated.

The sensor arrangement 2000 described herein can be attachable to an electrical appliance, such as a household electrical appliance, e.g. through the mating housing 850. The assembly 1000 can be reversibly connected to the mating connector 800.

Herein, the sensors of the electrical sensor assembly and/or kit can be reed sensors and/or hall sensors, for example. Herein, “housing” and “plug housing” can be used interchangeably with “electrical plug housing”. Herein, “board” can be used for “circuit board”, which can be used for “printed circuit board”. The kits described herein can optionally include a mating connector, such as in accordance with the mating connectors described herein. The kit 1001 described herein can include a mating connector 800 and can be for making a sensor arrangement 2000.

A list of reference numerals used herein is provided for convenience and is not intended to be limiting.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical sensor assembly, comprising:
an electrical plug housing for mating a mating connector,
a circuit board in the plug housing,
a plurality of terminals which make electrical contact to a surface of the circuit board, and
a sensor on the circuit board in electrical contact with a plurality of electrical connectors on the surface of the circuit board, wherein the electrical connectors press against the respective terminals for making the electrical contact.

2. The electrical sensor assembly of claim 1, wherein the electrical connectors of the circuit board are on a top surface of the circuit board, the electrical connectors of the circuit board are elastically pressed against the respective terminals, particularly the bottom surfaces thereof.

3. The electrical sensor assembly of claim 1, wherein the electrical plug housing includes a mating face for mating the mating connector, particularly exactly one connector face; wherein optionally, a cross section of the electrical plug housing at the mating face, and parallel thereto, is such that at least 60% of the cross-sectional area of the electrical plug housing is for mating to the mating connector.

4. The electrical sensor assembly of claim 1, wherein the plurality of terminals include at least one sensor terminal configured to transmit sensor data from the sensor; optionally at least two sensor terminals.

5. The electrical sensor assembly of claim 1, wherein the terminals include crimps, particularly crimps within the plug housing, such as crimps opposite to male or female ends of the terminals which are configured to mate complementary terminals at the connector face.

6. The electrical sensor assembly of claim 1, further comprising: a rear cover which covers an opening of the housing, the opening configured for insertion of the circuit board and terminals; the opening and rear cover being optionally on an opposite side of the housing as the mating face; wherein optionally the rear cover is a terminal position assurance member, TPA.

7. The electrical sensor assembly of claim 6, wherein the rear cover is reversibly attachable at the rear of the housing.

8. The electrical sensor assembly of claim 1, wherein the housing provides a cavity configured for insertion of a securing element for locking the electrical sensor assembly to the mating connector.

9. The electrical sensor assembly of claim 8, further comprising at least one latching member for engaging the mating connector; and a moveable member configured to release the at least one latching member from engagement with the mating connector.

10. The electrical sensor assembly of claim 9, wherein the securing element is reversibly insertable in the cavity; and wherein when the securing element is inserted in the cavity, the securing element prevents movement of the moveable member for releasing the electrical sensor assembly from the mating connector.

11. The electrical sensor assembly of claim 1, wherein the electrical sensor assembly is plug-like.

12. A sensor arrangement comprising:
an electrical sensor assembly including an electrical plug housing for mating a mating connector, a circuit board in the plug housing, a plurality of terminals which make electrical contact to a surface of the circuit board, and a sensor on the circuit board in electrical contact with a plurality of electrical connectors on the surface of the circuit board, wherein the electrical connectors press against the respective terminals for making the electrical contact; and
a mating connector that connects to the electrical plug housing, wherein the mating connector includes a plurality of complementary terminals that electrically connect to the terminals.

13. The sensor arrangement of claim 12, wherein the mating connector includes at least one attachment structure for attaching to an appliance, wherein optionally, the at least one attachment structure of the mating connector are the sole attachment structures for attaching to an appliance on the sensor arrangement; wherein optionally the attachment structures are on an outside surface of the mating connector.

14. The sensor arrangement of claim 12, wherein the housing provides a cavity configured for insertion of a securing element for locking the electrical sensor assembly to the mating connector, and wherein in a fully mated configuration, the electrical sensor assembly and the mating connector are fully mated, and the securing element is in a locking position in the cavity; and the securing element prevents movement of the moveable member for releasing the electrical sensor assembly from the mating connector.

15. The sensor arrangement of claim 12, wherein the electrical connectors of the circuit board are on a top surface of the circuit board, the electrical connectors of the circuit board are elastically pressed against the respective terminals, particularly the bottom surfaces thereof.

16. The sensor arrangement of claim 12, wherein the electrical plug housing includes a mating face for mating the mating connector, particularly exactly one connector face; wherein optionally, a cross section of the electrical plug housing at the mating face, and parallel thereto, is such that at least 60% of the cross-sectional area of the electrical plug housing is for mating to the mating connector.

17. The sensor arrangement of claim 12, wherein the plurality of terminals include at least one sensor terminal configured to transmit sensor data from the sensor; optionally at least two sensor terminals.

18. The sensor arrangement of claim 12, wherein the terminals include crimps, particularly crimps within the plug housing, such as crimps opposite to male or female ends of the terminals which are configured to mate complementary terminals at the connector face.

19. The sensor arrangement of claim 12, further comprising: a rear cover which covers an opening of the housing, the opening configured for insertion of the circuit board and terminals; the opening and rear cover being optionally on an opposite side of the housing as the mating face; wherein optionally the rear cover is a terminal position assurance member, TPA.

20. A kit comprising:
at least one circuit board;
a plurality of terminals;
a sensor on the at least one circuit board making electrical contact with a plurality of electrical connectors on the surface of the circuit board;
an electrical plug housing configured for mating a mating connector, wherein
the housing is configured for insertion of the plurality of terminals and one of the at least one circuit board;
wherein the electrical connectors on the surface of the circuit board are configured to make electrical contact to the terminals when the circuit board and the terminals are in the electrical plug housing.
